(19) United States
(12) Patent Application Publication
(10) Pub. No.: US 2014/0266906 A1
(43) Pub. Date: Sep. 18, 2014

(54) ANGLE DIVERSITY RECEIVING APPARATUS

(71) Applicant: NEC CORPORATION, Tokyo (JP)

(72) Inventor: Takayuki Murai, Tokyo (JP)

(73) Assignee: NEC CORPORATION, Tokyo (JP)

(21) Appl. No.: 14/215,478

(22) Filed: Mar. 17, 2014

(30) Foreign Application Priority Data
Mar. 18, 2013 (JP) 2013-054477

(51) Int. Cl. H04B 7/10

(52) U.S. Cl. CPC H04B 7/10
USPC 342/385

(57) ABSTRACT

An angle diversity receiving apparatus, which includes a receiving horn, a band pass filter, a low noise amplifier, a down converter and an automatic gain control unit, includes a diversity synthesis circuit which combines a plurality of branch signals, a decision feedback equalizer which regenerates a receiving signal on the basis of an output of the diversity synthesis circuit, a control unit which controls an angle of a receiving beam on the basis of the plural branch signals and an error signal of the decision feedback equalizer, and a horn driving unit which drives the receiving horn according to the control unit so that the angle of the receiving beam may be identical with a predetermined angle.

The control unit controls the horn driving unit so that a receiving level may become maximum in a range of a correlation coefficient which can generate a diversity effect.

This application is based upon and claims the benefit of priority from Japanese Patent Application No. 2013-054477, filed on Mar. 18, 2013, the disclosure of which is incorporated herein in its entirety by reference.

### TECHNICAL FIELD

The present invention relates to a diversity receiving apparatus, and in particular, relates to an angle diversity receiving apparatus.

### BACKGROUND ART

According to the angle diversity method, two receiving beams of one antenna are arranged, and radio waves, which arrive from directions different each other, are received by use of the respective beams, and consequently it is possible to obtain the same diversity effect as the space diversity, which uses two receiving antennas, obtains.

An example of an angle diversity receiving apparatus is shown in FIG. 6. The angle diversity receiving apparatus includes an antenna 100 which is equipped with two receiving horns 101a1 and 101a2. The angle diversity receiving apparatus limits bandwidths of signals, which are received by the receiving horns 101a1 and 101a2 respectively, by use of BPFs (Band Pass Filter) 102a1 and 102a2. Next, the signals whose bandwidths are limited are down-converted by LNAs (Low Noise Amplifier) 103a1 and 103a2, and D/Cs (Down Converter) 104a1 and 104a2 respectively. Then, the down-converted signals are processed by AGCs (Automatic Gain Controller) 105a1 and 105a2, and afterward outputs of AGCs 105a1 and 105a2 are used as two branch signals of the angle diversity in the receiving process. Next, the diversity synthesis and the automatic equalization are carried out to each branch signal by AMFs (Adaptive Matched Filter) 106a1 and 106a2, a diversity synthesis circuit 107 and DFE (Decision Feedback Equalizer) 108 to regenerate a receiving signal.

In the example shown in FIG. 6, angles of the receiving horns 101a1 and 101a2 are adjusted, and the receiving horns are fixed so as to realize an optimum angle between receiving beams.

According to the angle diversity method, it is general that the angles of two receiving horns are set so as to realize the optimum angle between receiving beams. However, in the case that the receiving horn is fixed at a specific angle, there is a problem that a level of received radio-wave decreases when a radio-wave arrival direction angle changes due to a change in a radio-wave propagation situation.

As a means to solve the problem mentioned above, diversity technologies using a delay element are disclosed in a patent document 1 and a patent document 2.

Furthermore, a technology about the polarization diversity is disclosed in a patent document 3.

[Preceding Technical Document]

[Patent Document]

[Patent document 1] Japanese Patent Application Laid-Open No. 1994-029890

[Patent document 2] Japanese Patent Application Laid-Open No. 1993-344029

[Patent document 3] Japanese Patent Application Laid-Open No. 2010-233215

### SUMMARY

### Technical Problem

The arts disclosed in the patent documents 1 to 3 have a problem that a circuit scale becomes large and a circuit becomes complicated since a delay element and plural polarization diversity antennas are used.

An object of the present invention is to provide an angle diversity receiving apparatus which solves the problem mentioned above.

### Solution to Problem

In order to solve the above-mentioned problem, the present invention is an angle diversity receiving apparatus which includes: a receiving horn; a band pass filter; a low noise amplifier; a down converter; and an automatic gain control unit, and the angle diversity receiving apparatus is characterized in that the angle diversity receiving apparatus includes: a diversity synthesis circuit which combines a plurality of branch signals; a decision feedback equalizer which regenerates a receiving signal on the basis of an output of the diversity synthesis circuit; a control unit which controls an angle of a receiving beam on the basis of the plural branch signals and an error signal of the decision feedback equalizer; and a horn driving unit which drives the receiving horn according to the control unit so that the angle of the receiving beam may be identical with a predetermined angle; and the control unit controls the horn driving unit so that a receiving level may become maximum in a range of a correlation coefficient which can generate a diversity effect.

The present invention is an angle diversity receiving apparatus which uses a phased array, and the angle diversity receiving apparatus is characterized in that: the angle diversity receiving apparatus includes: a diversity synthesis circuit which combines a plurality of branch signals; a decision feedback equalizer which regenerates a receiving signal on the basis of an output of the diversity synthesis circuit; a control unit which controls an angle of a receiving beam on the basis of the plural branch signals and an error signal of the decision feedback equalizer; and a phased array synthesis unit which controls the plural phased arrays according to the control unit so that an angle between receiving beams may be identical with a predetermined angle; and the control unit controls the angle between receiving beams of the plural phased arrays so that the error signal may become minimum in a range of a correlation coefficient which can generate a diversity effect, and controls the phased array synthesis unit so that a receiving level may become maximum with keeping the angle between receiving beams.

### Advantageous Effect of Invention

An effect of the present invention is that even if the radio-wave arrival direction angle changes, the angle diversity receiving apparatus can obtain the diversity effect and can make the receiving level maximum in a range where the diversity effect cab be obtained without a delay element and plural polarized wave diversity antennas being used and a circuit scale being greatly complicated.

### BRIEF DESCRIPTION OF THE DRAWINGS

Exemplary features and advantages of the present invention will become apparent from the following detailed description when taken with the accompanying drawings in which:

[FIG. 1] is a block diagram exemplifying a configuration of an angle diversity receiving apparatus according to a first exemplary embodiment of the present invention;

[FIG. 2] is a diagram which shows a relation between a correlation relation and an angle between beams, and a relation between a beam deviation loss and the angle between beams;

[FIG. 3] is a block diagram exemplifying a detailed configuration of the angle diversity receiving apparatus according to the first exemplary embodiment of the present invention;

[FIG. 4] is a block diagram exemplifying a configuration of an angle diversity receiving apparatus according to a second exemplary embodiment of the present invention;

[FIG. 5] is a block diagram exemplifying a configuration of an angle diversity receiving apparatus according to a third exemplary embodiment of the present invention; and

[FIG. 6] is a block diagram exemplifying a configuration of an angle diversity receiving apparatus according to an art which is related to the present invention.

### EXEMPLARY EMBODIMENT

Hereinafter, an exemplary embodiment of the present invention will be described in detail with reference to a drawing.

### First Exemplary Embodiment

FIG. 1 is a block diagram exemplifying a configuration of a receiving apparatus according to the first exemplary embodiment of the present invention.

In FIG. 1, an angle diversity receiving apparatus according to the present invention includes an antenna 300, which includes two receiving horns 301a1 and 301a2 arranged in a receiving horn portion 310, and BPFs 302a1 and 302a2. Moreover, the angle diversity receiving apparatus includes LNAs 303a1 and 303a2, D/Cs 304a1 and 304a2, AGCs 305a1 and 305a2, and AMFs 306a1 and 306a2. Furthermore, the angle diversity receiving apparatus, which includes a diversity synthesis circuit 307, DFE 308 and a control unit 309, carries out the diversity synthesis and the automatic equalization to regenerate a receiving signal.

FIG. 3 is a diagram which shows a part of FIG. 1 in detail. The control unit 309 includes a correlator 401 and a control circuit 402 in the inside. The receiving horn portion 310 includes the receiving horns 301a1 and 301a2, and a horn driving unit 403. Here, the horn driving unit 403 is a driving unit which changes a direction angle of each of the receiving horns 301a1 and 301a2.

An operation will be described with reference to FIG. 1, FIG. 2 and FIG. 3.

According to the angle diversity method, an antenna beam is used with being deviated from the optimum direction. As a result, an average level of a receiving input signal is decreased in comparison with a case of receiving radio-wave from the optimum direction. An amount of the decrease is called the antenna beam deviation loss. As an angle between receiving beams becomes large, the antenna beam deviation loss becomes large. On the other hand, it is necessary to make a correlation value between branches smaller than a predetermined value in order to obtain a diversity effect. In order to make the correlation value between branches small, it is necessary to make the angle between receiving beams large. FIG. 2 shows a relation between a correlation coefficient and the angle between beams, and a relation between the beam deviation loss and the angle between beams. Due to the above mention, according to the angle diversity method, the angle of receiving beams is set generally so that a balance of the antenna beam deviation loss and the correlation coefficient of the correlation between branches may be optimum.

Signals, which are received by the receiving horns 301a1 and 301a2, are processed by BPFs 302a1 and 302a2, LNAs 303a1 and 303a2, D/Cs 304a1 and 304a2, and AGCs 305a1 and 305a2 respectively, and then outputs of AGCs 305a1 and 305a2 are corresponding to two branch signals of the angle diversity. Next, the branch signals are inputted to AMFs 306a1 and 306a2 respectively, and the angle diversity synthesis is carried out by the diversity synthesis circuit 307. The output of the diversity synthesis circuit 307 is equalized automatically by DFE 308, and an error signal and a received data signal are obtained from DFE 308.

The control unit 309 receives the outputs of AGC 305a1 and 305a2, and makes the correlator 401 carry out a correlation operation. In the correlation operation, the angle between two receiving horns is changed gradually, and a plurality of output values at certain angles are recorded, and calculation is carried out by use of the values. Moreover, the control unit 309 receives the correlation coefficient which is the result of the correlator 401 carrying out the correlation operation, and the error signal, which is provided by DFE 308, by use of the control circuit 402. The control circuit 402 sends an amount of change Δ θ in the angle between receiving beams of the receiving horns 301a1 and 301a2, which makes the error signal minimum in a range of the value of the correlation coefficient able to obtain the diversity effect, to the horn driving unit 403. Practically, it is desirable that the correlation coefficient is not larger than 0.7.

The horn driving unit 403 receives the amount of change Δ θ in the angle between receiving beams from the control circuit 402, and sets the angle between receiving beams to be optimum by driving the receiving horns 301a1 and 301a2. Furthermore, the horn driving unit 403 changes directions of the receiving horns 301a1 and 301a2 simultaneously with keeping the angle between receiving beams optimum, and carries out control so that a receiving level may become maximum.

According to the present invention, even if the radio-wave arrival direction angle changes, it is possible to obtain the diversity effect and to make the receiving level maximum in a range where the diversity effect can be obtained as mentioned above without a delay element and plural polarized wave diversity antennas being used and a circuit scale being greatly complicated.

### Second Exemplary Embodiment

FIG. 4 shows a configuration in which number of the receiving horns and receiving mechanisms increases to n, and the diversity synthesis is carried out by use of the receiving horns and receiving mechanisms as the branches of the angle diversity.

In FIG. 4, an antenna 500 includes a receiving horn portion 510 in which n horns of receiving horns 501a1 to 501an are arranged, and each of the n horns receives a signal. Outputs of n horns are processed by BPFs 502a1 to 502an, LNAs 503a1 to 503an, D/Cs 504a1 to 504an and AGC 505a1 to 505an respectively, and then output signals of AGC 505a1 to 505an are corresponding to n branch signals of the angle diversity. After the outputs of AGC 505a1 to 505an are processed by AMFs 506a1 to 506an respectively, a diversity synthesis circuit 507 carries out the synthesis of the angle diversity on the basis of the outputs of AMFs 506a1 to 506an. The n output signals of AGC 505a1 to 505an and an error signal provided by DFE 508 are inputted to a control unit 509.

The control unit 509 receives the outputs of AGC 505a1 to 505an, and carries out a correlation operation by use of a correlator 551. Moreover, the control unit 509 receives a correlation coefficient which is the result of the correlator 551 carrying out the correlation operation, and the error signal, which is provided by DFE 308, by use of a control circuit 552. The control circuit 552 sends an amount of change Δ θ in an angle between receiving beams of the receiving horns 501a1 and 501a2, which makes the error signal minimum in a range of the value of the correlation coefficient which can obtain the diversity effect, to a horn driving unit 451. The n receiving horns receive signals from directions different each other, and a direction of each horn is controlled so that a receiving level may become high as a whole.

For example, an angle between receiving beams of 501a1 and 501a2 is determined firstly by the control unit 509 controlling the correlator 551 like the first exemplary embodiment. Next, an angle between receiving beams of 501a2 and 501a3 is determined similarly. This process is repeated, and then an angle between receiving beams of 501a(n−1) and 501an is determined finally.

The receiving horns 501a1 to 501an are arranged on a circumference, and the angle of receiving beams is set to be optimum by the horn driving unit 451 on the basis of the amount of change Δ θ in the angle between receiving beams which is provided by the control circuit 552. Furthermore, with keeping the angle between receiving beams optimum, the horn driving unit 451 makes the receiving horns 501a1 to 501an rotated in a direction of the circumference by the same distance, and carries out control so as to make a receiving level maximum.

Moreover, by driving the receiving horns 501a1 to 501an in a central direction, the horn driving unit 451 can carry out also the control so as to make the receiving level high.

According to the present invention, even if the radio-wave arrival direction angle changes, it is possible to obtain the diversity effect and to make the receiving level maximum in a range where the diversity effect can be obtained as mentioned above without a delay element and plural polarized wave diversity antennas being used and a circuit scale being greatly complicated.

### Third Exemplary Embodiment

FIG. 5 exemplifies a configuration according to a third exemplary embodiment of the present invention.

Phased array synthesis units 610a1 and 610a2 carry out the phased array synthesis, and outputs of the phased array synthesis units 610a1 and 610a2 compose two branch signals of the angle diversity. Then, a diversity synthesis circuit 607 carries out the angle diversity synthesis. An adjustment of an angle between receiving beams is carried out not by driving an antenna element to change a direction but by controlling a direction of a receiving beam in the phased array synthesis unit.

N receiving signals from a phased array antenna, which includes n antenna elements 601a1 to 601an, are processed by BPFs 602a1 to 602an, LNAs 603a1 to 603an, D/Cs 604a1 to 604an and AGCs 605a1 to 605an respectively, and output signals of AGCs 605a1 to 605an are inputted to the phased array synthesis units 610a1 and 610a2 respectively. Afterward, the phased array synthesis units 610a1 and 610a2 carry out the phased array synthesis, and output signals of the phased array synthesis units 610a1 and 610a2 are inputted to the diversity synthesis circuit 607 through AMFs 606a1 and 606a2 respectively, and then the diversity synthesis circuit 607 carries out the synthesis of the angle diversity. A control unit 609 is inputted the output signals of the phased array synthesis units 610a1 and 610a2, and an error signal which is provided by DFE 608.

The control unit 609 receives the outputs of the phased array synthesis units 610a1 and 610a2, and carries out a correlation operation by use of a correlator 651. Moreover, the control unit 609 receives a correlation coefficient which is the result of the correlator 651 carrying out the correlation operation, and an error signal, which is provided by DFE 308, by use of a control circuit 652 similarly to the first exemplary embodiment. The control circuit 652 controls the phased array synthesis units 610a1 and 610a2 so as to make the error signal minimum in a range of the value of the correlation coefficient which can obtain the diversity effect.

The phased array synthesis units 610a1 and 610a2 receive an amount of change Δ θ in the angle between receiving beams from the control circuit 652, and carry out the phased array synthesis, and sets the angle between receiving beams to be optimum. Furthermore, with keeping the angle between receiving beams optimum, the phased array synthesis units 610a1 and 610a2 change directions of the phased array synthesis simultaneously, and carry out control so that a receiving level may become maximum.

According to the present invention, even if the radio-wave arrival direction angle changes, it is possible to obtain the diversity effect and to make the receiving level maximum in a range where the diversity effect can be obtained as mentioned above without a delay element and plural polarized wave diversity antennas being used and a circuit scale being greatly complicated.

Here, the present invention is not limited to the above-mentioned exemplary embodiment, and can be carried out with including various changes and modifications within a scope not departing from the principle of the present invention.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

### INDUSTRIAL APPLICABILITY

The present invention is applicable to communication which uses the angle diversity under an environment of the multipath fading propagation.

The invention claimed is:

1. An angle diversity receiving apparatus, which includes a receiving horn, a band pass filter, a low noise amplifier, a down converter and an automatic gain control unit, characterized in that:
said angle diversity receiving apparatus includes:
a diversity synthesis circuit which combines a plurality of branch signals;
a decision feedback equalizer which regenerates a receiving signal on the basis of an output of said diversity synthesis circuit;
a control unit which controls an angle of a receiving beam on the basis of said plural branch signals and an error signal of said decision feedback equalizer; and
a horn driving unit which drives said receiving horn according to said control unit so that said angle of said receiving beam may be identical with a predetermined angle, and
said control unit controls said horn driving unit so that a receiving level may become maximum in a range of a correlation coefficient which can generate a diversity effect.

2. The angle diversity receiving apparatus according to claim 1, characterized in that:
said control unit includes:
a correlator which calculates a correlation coefficient on the basis of said plural branch signals; and
a control part outputting a signal, which controls an angle between receiving beams on the basis of outputs of said decision feedback equalizer and said correlator so that said error signal may become minimum in a range of the value of said correlation coefficient able to generate the diversity effect, to said horn driving unit.

3. The angle diversity receiving apparatus according to claim 1, characterized in that:
number of said plural branch signals is 2.

4. The angle diversity receiving apparatus according to claim 1, characterized in that:
number of said plural branch signals is n; and
said control unit includes said control part outputting a signal, which controls an angle between receiving beams of said receiving horns on the basis of outputs of said decision feedback equalizer and said correlator so that said error signal may become minimum in a range of the value of said correlation coefficient able to generate the diversity effect, to said horn driving unit.

5. An angle diversity receiving apparatus, which uses a phased array, characterized in that:
the angle diversity receiving apparatus includes:
a diversity synthesis circuit which combines outputs of plural branches;
a decision feedback equalizer which regenerates a receiving signal on the basis of an output of said diversity synthesis circuit;
a control unit which controls a receiving beam on the basis of outputs of said plural branches and an error signal of said decision feedback equalizer; and
a phased array synthesis unit which controls said plural phased arrays according to said control unit so that an angle between receiving beams may be identical with a predetermined angle, and
said control unit controls said angle between receiving beams of said plural phased arrays so that said error signal may become minimum in a range of a correlation coefficient which can generate a diversity effect, and controls said phased array synthesis unit so that a receiving level may become maximum with keeping said angle between receiving beams.
